(19) United States
(12) Patent Application Publication
(10) Pub. No.: US 2014/0272009 A1
(43) Pub. Date: Sep. 18, 2014

(54) Chewy Granola Bar With Carbonated Candy

(71) Applicant: PEPSICO, INC., Purchase, NY (US)

(72) Inventors: Danielle Barbaro, River Vale, NJ (US); John Behrens, Poughkeepsi, NY (US); Yang Kou, White Plains, NY (US)

(73) Assignee: PepsiCo, Inc., Purchase, NY (US)

(21) Appl. No.: 13/802,953

(22) Filed: Mar. 14, 2013

(51) Int. Cl. A23G 3/48; A23G 3/54

(52) U.S. Cl. CPC A23G 3/48; A23G 3/54
USPC 426/93; 426/272; 426/618

(57) ABSTRACT

A chewy granola product and a method of cold form sheeting such chewy granola product from a combination of dry granola, binder, and a carbonated candy.

### FIELD OF INVENTION

The present invention is directed to chewy granola products containing carbonated candy and methods of making these chewy granola products.

### BACKGROUND

Chewy granola base products have been commercially available and typically contain rolled oats, binders, and optional additional ingredients to enhance one or taste or dietary factors. Examples of commercially available chewy granola base products include QUAKER® Chewy Granola Bars which come in a variety of flavors such as chocolate chip and peanut butter. Other examples include Nature Valley Chewy Trail Mix Bars.

Carbonated candy has been commercially available and typically consists of tiny sugar crystals containing highly pressurized carbon dioxide and low percentages of water. Carbonated candy is also generally coated with a sufficient amount of an edible fat and or oil such that the total amount of solid fat components maintains the carbonated candy in solid form. One example of commercially available carbonated candy is POP ROCKS®.

### SUMMARY

The present invention relates to a method of making a chewy granola products containing carbonated candy. The present invention utilizes cold formed sheeting of the chewy granola product base that incorporates a carbonated candy particulate mixture either therein or as a coating to the chewy granola product base.

### BRIEF DESCRIPTION OF THE DRAWINGS

FIG. 1 is a flow chart depicting one aspect of an embodiment of the invention wherein the coated carbonated candy is distributed within the chewy granola product base.

FIG. 2 is a flow chart depicting another aspect of an embodiment of the invention wherein the coated carbonated candy is applied to the surface of the chewy granola product base.

### DETAILED DESCRIPTION

Various examples and embodiments of the inventive subject matter disclosed here are possible and will be apparent to the person of ordinary skill in the art, given the benefit of this disclosure. In this disclosure reference to “some embodiments,” “certain embodiments,” “certain exemplary embodiments” and similar phrases each means that those embodiments are merely non-limiting examples of the inventive subject matter, and there are alternative embodiments which are not excluded. Unless otherwise indicated or unless otherwise clear from the context in which it is described, alternative and optional elements or features in any of the disclosed embodiments and examples are interchangeable with each other. That is, an element described in one embodiment or example should be understood to be interchangeable or substitutable for one or more corresponding but different elements in another described example or embodiment and, likewise, an optional feature of one embodiment or example may optionally also be used in other embodiments and examples. More generally, the elements and features of any disclosed example or embodiment should be understood to be disclosed generally for use with other aspects and other examples and embodiments. A reference to a component or ingredient being operative or configured to perform one or more specified functions, tasks and/or operations or the like, is intended to mean that it can perform such function(s), task(s) and/or operation(s) in at least certain embodiments, and may well be able to perform also one or more other functions, tasks and/or operations.

In accordance with aspects of the invention, cold form sheeting can be used to make the chewy granola product as well a chewy granola base product. Chewy granola products are well-known in the art. For example, U.S. Pat. No. 4,451,488 issued to Cook et al, on May 29, 1984 teaches the composition and manufacture of chewy granola products and is hereby incorporated by reference. Typical chewy granola base products are made from dry particulates, one or more binders, and may optionally include one or more enhancements, toppings, or coatings. Additionally, chewy granola base products may also include additional optional components such as additional grains, fruits, nuts, seeds, fats, proteins, caffeine or other well-known additives or nutritional supplements so as to enhance specific properties such as taste, nutritional value, or marketability of the chewy granola product.

The granola base of the chewy granola product or chewy granola base product typically comprise a mixture of rolled oats (mixed with a proportional amount of honey that is well known to those of ordinary skill in the art), nuts, and other optional ingredients in proportions well known to those of ordinary skill. The granola base of the chewy granola product or chewy granola base product may then be optionally baked until crisp before being granulated. Typical methods and parameters well known to those of ordinary skill can be used to optionally bake the granola base of the chewy granola product or chewy granola base product. Generally the proportions of the dry components (e.g., the rolled oats, nuts and other optional ingredients) of the chewy granola base range from about 30 to about 80 weight % rolled oats, and from about 20 to about 40 weight % nuts. The granola base may additionally contain optional ingredients such as nuts, crispy rice, fruits, seeds, other grains, or other dry cereals in proportions also well-known to those of ordinary skill in a weight % from about 25 to about 45 weight percent.

The binder of the chewy granola product or chewy granola base product is typically a binder similar to those used in the formulation of other chewy granola snacks such as high maltose corn syrup, honey, fructose, canola oil, maltodextrin or combinations thereof. The proportion of binder used in relation to the amount of granola base use is commonly known in the art and typically ranges from about 65% to 35% to about 35% to 65% by weight. The binder and the granola base can be mixed together using methods and parameters well known to those of ordinary skill in the art. Generally, these well-known methods are performed at temperatures from about 70 to about 140° F. for at least around 5 minutes.

The granola base may also contain other optional enhancements, toppings or coatings such as nut pieces, chocolate, chocolate melts, caramel drizzle, peanut butter, or yogurt coatings. The amount and manner of incorporation of the optional enhancements, toppings, or coatings are well known to those of ordinary skill.

Carbonated candy is typically a candy with flavorings. One group of flavorings available for use in carbonated candy are those flavorings consistent with the flavors of carbonated soda. In this manner, carbonated candy is an alternative way of enjoying the experience from consumption of carbonated beverages as the carbonated candy produces a bubbling sensation in a user's mouth that is sensorially comparable to the bubbling sensation in a user's mouth that is experienced when drinking carbonated beverages. Carbonated candy is generally a product with tiny sugar crystals containing highly pressurized carbon dioxide and approximately 2% to 3% water and coated with a sufficient amount of an edible fat and or oil such that the total amount of solid fat components maintains the carbonated candy in solid form at normal ranges of room temperature and pressure.

There are several carbonated candy products, such as POP ROCKS® and methods of making carbonated candy products that are well known to those of ordinary skill. The carbonated candy is flavored with any well-known fruit or dark flavors typical of the flavors found in carbonated beverages. While any fruit or dark flavor can be used, some of the more common fruit flavors for carbonated beverages that can be used in carbonated candy include berry flavors such as, for example, acai, blueberry, cranberry, grape, strawberry, or raspberry. Other common fruit flavors are citrus flavors such as, for example lemon, lime, orange, or citrus flavors associated with particular carbonated beverages such as Mountain Dew or Sierra Mist. Common dark flavors of carbonated beverages include, for example, flavors such as cola, cream soda, root beer, vanilla soda, chocolate soda, maple, caramel, or cinnamon.

A problem with carbonated candy is that it must not be exposed to moisture during processing or storage. Otherwise, the carbonated candy will “pop” prematurely and not provide the desired “pop” in a consumer's mouth. Hence, it is important that prior to preparing the chewy bar, the carbonated candy has, or is coated with, a moisture impervious coating to ensure that premature popping does not occur during processing. During consumption (chewing), the coating is broken, exposing the carbonated candy therein. Moisture in the mouth then provides the catalyst to initiate popping and provide the desired carbonated soda feel.

Suitable coatings include, but are not limited to edible fats and oils such as chocolate or other similar compounds known to those of ordinary skill that would maintain a solid form at room temperature and pressure. Preferably these coatings would have a fat content generally from about 20 to about 40% by weight and a moisture content generally from about 1 to about 2% by weight. Optionally, the materials used as a binder may also be a suitable coating for the carbonated candy when the carbonated candy is distributed throughout the granola base product. Generally, these coatings are applied to the carbonated candy so that a coating thickness of around 0.5 cm is achieved. The coatings can be applied to the carbonated candy by methods well known to those of skill in the art, including but not limited to spray drying applications. Variations in the conditions and processes for applying the coating to the carbonated candy due to the use of a particular coating are well known to those of ordinary skill. Preferably these processes are done at lower temperatures lower than room so as to minimize the time for the coating to transform from a liquid to a solid state.

FIGS. 1 and 2 show two aspects of forming the chewy bar. FIG. 1 identifies exemplary process steps for manufacturing an exemplary aspect of the present invention wherein the coated carbonated candy is admixed throughout the chewy bar matrix. FIG. 2 identifies exemplary process steps for manufacturing an exemplary aspect of the present invention wherein the coated carbonated candy is provides as either an interior or exterior layer in the chewy bar.

The process of forming any particular granola base 100 used within the scope of this invention is dependent on the particular components and amounts used therein. Variations in the amounts or processing conditions of the granola base due to the use of particular components are well known to those of ordinary skill. Typically the granola base is composed of at least rolled oats or other dried cereal and honey with the optional inclusion of one or more types of nuts. The granola base generally contains from about 60 to about 80 weight percent rolled oats or other dried cereal and from about 1% to about 4% honey. If the optional nuts are included the nuts can range from about 20 to about 40 weight percent. The granola base is formed by mixing these ingredients and then baking them until crisp. Typical operational parameters for the baking of granola base product are well known to those of ordinary skill and generally range from about 95 to about 230° C. for a time period from about 1 to about 20 minutes.

After baking the granola base product, the granola base product is granulated 110, if necessary, to reduce the particulate size, and is then admixed with the binder composition.

The formation of the binder composition 120 can be done in many ways by those of ordinary skill and varies in both method and parameters based on the particular components used in the binder composition. For example, one binder composition within the scope of the present invention is formed from the mixing of high fructose corn syrup and honey followed by heating that mixture to about 105 to 115° F. After the combination of high fructose corn syrup and honey are mixed to an approximate homogeneous combination, dry components in the binder composition are added. Such dry components typically used in the binder composition include maltose, maltodextrin, salt, corn syrup solids, or starches. In one example of the binder composition, the maltose has a weight percent of from about 5 to about 10; the maltodextrin has a weight percent of from about 2 to about 5; the salt has a weight percent of from about 0.5 to about 1; the honey has a weight percent from about 5 to about 25; and the high fructose corn syrup has a weight percent from about 45 to about 75. The resulting preliminary binder composition is then mixed with oils at a weight percent ratio from about 3 to about 10 and heated to approximately 140° F. Optional flavor or nutritional enhancements can then be added to the binder composition or the granola base product as desired. The amount and method of addition of the optional flavor or nutritional enhancements is well known to those of ordinary skill.

After the optional flavor or nutritional enhancements are added to either the binder composition or the granola base, the binder and granola base are mixed into a homogeneous composition 140. The homogeneous composition is then formed into the chewy granola base using methods and processes well known to those of ordinary skill. For example, in one embodiment of the invention, the granola base and binder composition can be mixed to yield the homogeneous composition. The homogeneous composition can then be processed using cold form sheeting 150 to achieve the chewy granola product. The methods and operational parameters for cold form sheeting a chewy granola product vary depending on the particular granola base (including optional ingredient) and binder (including optional ingredients) and the general methods and parameters for cold form sheeting interior are well known to those of skill in the art and for example can generally range in operating temperatures from about 130 to about 160 F with a slurry brix density of 80.

In one exemplary embodiment within the present scope of the invention as shown in FIG. 1, the carbonated candy is added to the binder composition 130 prior to the mixing of the binder composition with the granola base described above. In this exemplary embodiment the amount of carbonated candy added is from about 1% to about 5% of the binder composition. The mixing of the carbonated candy within the binder composition prior to the binder composition being admixed with the granola base does not affect the general methods and parameters for cold form sheeting the homogeneous composition into the chewy granola product described above.

In another exemplary embodiment within the scope of the present invention as shown in FIG. 2, the coated carbonated candy is added to other optional ingredients to form either an interior or exterior layer of the optional ingredients 137. Typical interior or exterior layer optional ingredients such as chocolate, caramel, peanut butter, yogurt, nugget or combinations thereof are well known to those of ordinary skill. For example at 135 the carbonated candy may be added to a chocolate layer which is then used to coat all or a portion of the exterior of the chewy granola base. Alternatively in this embodiment the layer of carbonated candy can be incorporated as interior layers in the chewy granola product. The methods and operational parameters for incorporating either interior or exterior layers of optional ingredients including layers containing the carbonated candy within the chewy granola product or on its surface vary depending on the particular optional ingredients being used and the general methods and parameters for interior or exterior layering of known optional ingredients are well known to those of skill in the art. Alternatively, a purely exterior layer of optional ingredients including layers containing the coated carbonated candy can be applied to chewy granola products after their further processing into sizes and shapes suitable for commercial sale.

After the chewy granola products have completed processing in the cold form sheeting they are further processed 160 into sizes and shapes suitably for commercial sale by using cutting mechanisms well known to those of ordinary skill such as mechanical cutters that yield shapes such as rectangular bars, circles, or other geometric shapes.

Generally the chewy granola products will have a pH between about 5 to about 6 and a moisture content from about 7 to about 11% by weight and a water activity less than 0.65. Alternatively, the chewy granola products will have a pH between about 5 to about 6 and a moisture content from about 5 to about 7% by weight of total solids content and a water activity less than 0.65. Preferably, the water activity is from about 0.48 to about 0.57. Typically, the chewy granola product is processed into a bar shaped product through use of cutting methods such as mechanical cutters. This bar shaped product is typically around 100 mm×30 mm×16 mm and weight about 40 grams. However, other shapes and sizes of the chewy granola product such as bite-size pieces, orbs, donuts, and other three dimensional geometric shapes are contemplated within the scope of the invention and the manner of making these shapes is well known to those of ordinary skill.

After the chewy granola product is in its final commercial shape it can be packaged for commercial sale 170. Typical packaging for chewy granola products includes moisture barrier packaging to prevent moisture gain by the chewy granola product. Generally, moisture barrier packaging contain aluminum foil or other materials such as polymer blends or coated paper packaging so as to create a packaging material with a low water transmission rate for the typical shelf like conditions of the chewy granola product. Typical shelf-life conditions for chewy granola products would be approximately a year at or around standard room temperatures, humidities, and pressures.

As used in this disclosure, unless otherwise specified, the term “mix”, “mixing”, “added”, “adding”, “combined”, or “combining” and like terms means that the multiple ingredients or components referred to are combined in any manner and in any order, with or without stirring or the like, etc.

### EXAMPLE

The following example is a specific embodiment of the present invention but is not intended to limit it.

### Example 1

### Chewy Granola Bar Containing Coated Carbonated Candy Admixed Throughout

A granola base product used in the process of making an embodiment of the present invention was made using a dry ingredient mixture of 35% by weight rolled oats, 35% by weight rice crisp, 5% by weight almonds and 25% by weight peanuts The dry ingredients were then mixed and granulated The mixture was baked at about standard room temperatures and then granulated.

A binder used in the process of making an embodiment of the present invention was made using a mixture of approximately 65% by weight high maltose corn syrup, approximately 19% by weight honey, approximately 7% fructose, approximately 5% by weight canola oil, approximately 3% by weight maltodextrin, approximately 0.65% by weight salt, and approximately 0.35% by weight cola flavor powder. The binder was formed by mixing high maltose corn syrup and honey at standard room temperature until well mixed and then adding the additional components of the binder and mixing at room temperature until well-mixed.

About 3% by weight carbonated candy was then mixed with the about 57% by weight binder and about 40% by weight of the granola base product and a chewy granola product containing the coated carbonated candy was made using a cold form sheeting process at a temperature of about 140-160° F. The chewy granola product containing the coated carbonated candy was then mechanically cut into bars weighing approximately 40 grams and having dimensions of about 100×30×16 mm.

### Example 2

### Chewy Granola Bar Containing Coating Composition with Carbonated Candy

A granola base product is made in accordance with Example 1. The base is formed into a chewy granola product using a cold form sheeting process at a temperature of about 140-160° F.

A coating composition is prepared by combining coating ingredients and mixing in carbonated candy. The coating composition is applied to the chewy granola product and then the chewy granola product is mechanically cut into bars weighing approximately 40 grams and having dimensions of about 100×30×16 mm. Alternatively, the chewy granola product is mechanically cut into bars first and then the coating composition is applied to the entirety of the granola product.

While this disclosure mentions specific examples and embodiments, those skilled in the art will appreciate that there are numerous variations and modifications within the spirit and scope of the invention as set forth in the appended claims. Each word and phrase used in the claims is intended to include all its dictionary meanings consistent with its usage in this disclosure and/or with its technical and industry usage in any relevant technology area. Indefinite articles, such as “a,” and “an” and the definite article “the” and other such words and phrases are used in the claims in the usual and traditional way in patents, to mean “at least one” or “one or more.” The word “comprising” is used in the claims to have its traditional, open-ended meaning, that is, to mean that the product or process defined by the claim may optionally also have additional features, elements, etc. beyond those expressly recited in the claim.

What is claimed is:

1. A method of cold form sheeting a chewy granola product comprising:
a. combining dry granola and a binder to create a chewy granola base; and
b. combining the chewy granola base with a carbonated candy coated with a moisture impervious coating to create a chewy granola product.

2. The method of claim 1 further comprising:
a. cutting the chewy granola product; and
b. packaging said cut chewy granola product into moisture barrier packaging

3. The method of claim 1 wherein said carbonated candy is admixed with the chewy granola base.

4. The method of claim 1 where said carbonated candy is a coating on said chewy granola product.

5. The method of claim 1 wherein said chewy granola product has a moisture content from about 7 to about 11%.

6. The method of claim 1 wherein said chewy granola product has a pH from about 5 to about 6.

7. The method of claim 1 wherein said chewy granola base additionally includes other taste additives selected from the group consisting of raisins, fruits, nuts, chocolate, caramel, or peanut butter.

8. The method of claim 1 wherein said chewy granola base additionally includes other dietary enhancements selected from the group consisting of caffeine, fats, proteins, carbohydrates, or fibers.

9. The method of claim 1 wherein said carbonated candy is flavored.

10. The method of claim 1 wherein the flavor of the carbonated candy is a flavor also found in a carbonated beverage.

11. A chewy granola product comprising:
a. dry granola base;
b. a binder; and
c. carbonated candy having a moisture impervious coating.

12. The chewy granola product of claim 11 wherein said carbonated candy is integrated with said granola base and said binder.

13. The product of claim 11 where said carbonated candy is a coating on the mixture of dry granola base and binder.

14. The product of claim 11 wherein said chewy granola product has a moisture content from about 7 to about 11%.

15. The product of claim 11 wherein said chewy granola product has a pH from about 5 to about 6.

16. The product of claim 11 wherein said chewy granola base additionally includes other taste additives' selected from the group consisting of raisins, fruits, nuts, chocolate, caramel, or peanut butter.

17. The product of claim 11 wherein said chewy granola base additionally includes dietary enhancements selected from the group consisting of caffeine, fats, proteins, carbohydrates or fibers.

18. The product of claim 11 wherein said carbonated candy is flavored.

19. The product of claim 11 wherein the flavor of the carbonated candy is a flavor also found in a carbonated beverage.
